(19) United States
(12) Patent Application Publication
(10) Pub. No.: US 2026/0151216 A1
(43) Pub. Date: Jun. 4, 2026

(54) TEETH WHITENING STRIP SYSTEM

(71) Applicant: Benjamin Winters, Plano, TX (US)

(72) Inventor: Benjamin Winters, Plano, TX (US)

(21) Appl. No.: 18/964,689

(22) Filed: Dec. 2, 2024

(51) Int. Cl. A61C 19/06

(52) U.S. Cl. CPC A61C 19/066

(57) ABSTRACT

Described herein are a tooth whitening strip system comprising a plastic backing and at least one tooth whitening strip removably attached to the plastic backing, having a thin layer of coating of a tooth whitening gel, and having one or more perforations that allow for the whitening strip to be resized for contact only with the front surface of the user's teeth. At least one of the perforations also allows for the strip to be cut into two equally sized strips, resulting in two usable whitening strips from the original single-use strip.

### STATEMENT REGARDING FEDERALLY SPONSORED RESEARCH OR DEVELOPMENT

The present invention was made with no government support.

### RELATED PATENT APPLICATIONS AND INCORPORATION BY REFERENCE

Not applicable

### FIELD OF THE INVENTION

The present invention relates generally to oral hygiene. More particularly, the invention is directed to teeth whitening strips. Specifically, the present invention is directed to a unique thin, flexible strip of material coated with a whitening agent that comes into contact with a user's teeth to remove stains and discoloration. The present invention provides a whitening strip that can be re-sized to fit teeth of varying size or cut in half to double strip usage.

### BACKGROUND OF THE INVENTION

Recent data calculated by Statista reveals that over 35 million Americans used tooth whiteners each year since at least the year 2020. A variety of over-the-counter tooth whitening systems have long been available, including whitening toothpastes and many whitening systems comprised of a thin strip of plastic film with a tooth whitening composition applied thereto.

Teeth whitening strips are thin, flexible plastic strips coated with a gel containing a whitening agent, such as hydrogen peroxide or carbamide peroxide. Most whitening strips are made out of a thin, elastic plastic such as polyethylene. Although there are a variety of professional teeth whitening procedures which may be performed in a dentist's office, over-the-counter at home whitening systems are a very popular lower cost alternative to professional treatment. In addition to the lower cost, whitening strips are typically quite easy to use. Most teeth whitening kits come with two sets of strips. One set of strips is for the upper teeth and the other set is for the lower teeth.

Presently known over-the-counter teeth whitening systems have proven to be quite effective in giving users the desired result. While having a professional perform teeth whitening treatment is generally more effective overall, teeth whitening strips are a more convenient and less expensive alternative. Also, teeth whitening strips can be used at the user's convenience, rather than having to schedule an appointment. For only slightly discolored teeth, it further may not be worth paying the expense of a full professional teeth whitening.

Although teeth whitening strips provide a more convenient, cost-effective way to whiten teeth, they often can cause tooth sensitivity and gum irritation. This discomfort is normally temporary and may last for up to several days, however use of teeth whitening strips does not cause permanent damage. The irritation occurs due to whitening products containing some amount of hydrogen peroxide or carbamide peroxide and the peroxides penetration of the tooth enamel to the soft layer of dentin where the nerve is located.

A variety of over-the-counter whitening systems are available. Conventional teeth whitening strips are applied by placing the gel side of the strip on the user's front teeth and folding the strip behind the teeth. These strips typically contact the front surface of the user's teeth as well as, at least partially, the biting edge and the back surface of the user's teeth. Because only the front surface of the teeth is visible, there is no need for the whitening strips to contact the biting edge or the back surface of the teeth. There is a need for an improved teeth whitening strip that contacts the minimal amount of tooth surface, thereby minimizing the irritation and discomfort caused by the whitening gel.

Several teeth whitening strips and methods of using the strips are disclosed in patents, such as U.S. Pat. Nos. 6,551,579, 7,122,199, and 10,285,916. However, there is still a need for an improved whitening strip that can be easily re-sized to accommodate different sizes of teeth and to contact only the front of the user's teeth.

Furthermore, what is needed is a teeth whitening strip system that will permit the user to split the whitening strip into two, without scissors, thereby allowing for twice the number of uses for a single whitening strip.

### SUMMARY OF THE INVENTION

In view of the above, it is an object of the present invention to overcome the shortfalls in the related art by presenting an improved teeth whitening strip system.

In a preferred embodiment, the tooth whitening strip system comprises a plastic backing and a first and second whitening strip, each comprised of flexible plastic material forming a strip that is coated with a thin layer of whitening gel. Each whitening strip includes at least one perforation at which the respective strip may be torn, resulting in two equally sized whitening strips, thereby allowing for two whitening uses from each original untorn, single-use whitening strip. Further, each set of two equally sized whitening strips are sized to preferably contact only the front surface of the user's teeth during use. Alternatively, the whitening strips may be untorn and used in the conventional manner such that each whitening strip contacts the front surface and the rear surface of the user's teeth when applied by the user for whitening.

In another preferred embodiment of the present invention, the whitening strip system includes two whitening strips, each having a first perforation and a second perforation, wherein the whitening strip may be torn at the first perforation, resulting in two equally sized whitening strips. Alternatively, each whitening strip may be torn only at a second respective perforation, resulting in two whitening strips of varying size, wherein the first whitening strip is sized for application to the front face of medium to large sized teeth and the second whitening strip is sized for application to the front face of smaller sized teeth.

### BRIEF DESCRIPTION OF THE DRAWINGS

FIG. 1 is a front view of an embodiment of the present invention.

FIG. 2 is a front view of an embodiment of the present invention, illustrating preferred dimensions of said preferred embodiment.

FIG. 3 is a partial perspective view of a preferred embodiment of the present invention, illustrating how the whitening strips are removably fixed to a plastic backing.

### DETAILED DESCRIPTION

The following detailed description is merely exemplary in nature and is not intended to and should not be interpreted to limit the embodiments described herein. Although particular embodiments are described, those embodiments are merely exemplary implementations of the system of the present invention. The following descriptions and illustrations herein should be considered illustrative in nature, and thus, not in any way limiting the scope of the present invention. One skilled in the art will recognize other embodiments are possible and all such embodiments are intended to fall within the scope of the present disclosure. While the preferred embodiments are described with reference to the above drawings, there is no intent to limit the disclosure to the embodiments shown in the drawings or disclosed herein. Rather, the intent is to include all alternatives, modifications and equivalents that embody the spirit and scope of the disclosure.

It is also to be understood that the disclosure uses terminology for the purpose of describing particular embodiments and such terminology is not intended to be limiting.

Unless defined otherwise, all technical and scientific terms used in this disclosure have the same meaning as commonly understood by one of ordinary skill in the art to which is applicable to this disclosure.

As will be apparent to those of skill in the art upon reading this disclosure, each of the embodiments described and illustrated herein has discrete components and features which may be readily separated or combined with features of any of the other possible embodiments without departing from the spirit and scope of the present disclosure.

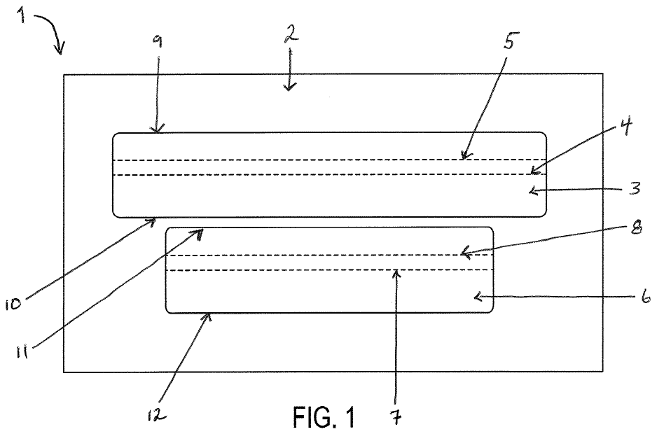

Referring to the drawings more particularly by reference number, reference number 1 refers to a teeth whitening strip system in accordance with the present invention. The teeth whitening system 1 is designed for use as a do-it-yourself teeth whitening strip. An illustrative teeth whitening strip system 1 of the present invention is shown in FIG. 1.

As shown in the embodiment illustrated in FIG. 1, the teeth whitening system 1 preferably comprises a plastic backing 2 and a flexible plastic material forming a first whitening strip 3 and a second whitening strip 6, each of which is coated with a thin layer of whitening gel (not shown). The whitening strips 3, 6 are preferably comprised of a thin, flexible polyethylene or similar material. However, those skilled in the art would understand any other suitable flexible plastic or plastic-like material may be employed for the whitening strips 3, 6. The whitening agent or whitening gel may be hydrogen peroxide, carbamide peroxide or any other suitable whitening agent known in the art.

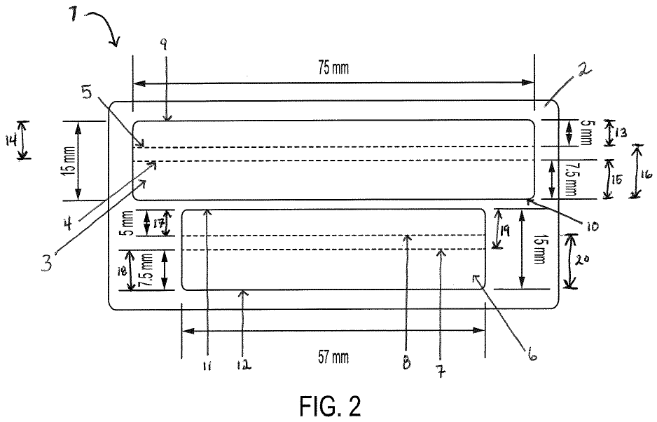

The first whitening strip 3 has a first edge 9 and a second edge 10, as shown in FIG. 1. The first whitening strip 3 further has at least one perforation 4, at which the strip 3 may be torn, resulting in two equally or substantially equally sized whitening strips. The first of the resulting equally sized strips spans from the first edge 9 of the first whitening strip 3 to the perforation 4 and has a width shown in FIG. 2 represented by the reference number 14. The second of the resulting equally sized strips spans from the second edge 10 of the first whitening strip 3 to the perforation 4 and has a width shown in FIG. 2 represented by the reference number 15. By tearing the first whitening strip 3 into two equally or substantially equally sized strips, the user is provided the benefit of having two strips that may be used separately for two separate teeth whitening procedures, rather than the single use afforded when using the entire first whitening strip 3 for a single teeth whitening procedure. When the user employs use of only one of the equally sized strips resulting from tearing the first whitening strip 3 into two separate strips, the whitening strip 3 may advantageously be positioned to preferably only contact the front surface of the user's top row of teeth. Depending upon the size of the user's teeth, the resulting strips may also contact mostly the front surface of the user's top row of teeth, but also partially or minimally contact the bottom edge and the rear surface of the user's top row of teeth. Of course, alternatively, the first whitening strip 3 may be untorn and used in the conventional, single use manner such that the first whitening strip 3 contacts the front surface and the rear surface of the user's upper row of teeth when applied by the user for whitening.

FIG. 1 also shows a second perforation 5 of the first whitening strip 3, at which the strip 3 may alternatively be torn, resulting in two whitening strips of varying size. The larger of the two resulting strips spans from the second edge 10 of the first whitening strip 3 to the perforation 5 and has a width shown in FIG. 2 represented by the reference number 16. The smaller of the two resulting strips spans from the first edge 9 of the first whitening strip 3 to the perforation 5 and has a width shown in FIG. 2 represented by the reference number 13. The benefit of this perforation 5 is to provide two separate whitening strips that are each sized preferably to only contact the front surface of the user's top row of teeth, with the resulting smaller sized strip being suitable for a user with relatively smaller sized teeth and the resulting larger sized strip being suitable for a user with relatively medium-to-larger sized teeth. Depending upon the size of the user's teeth, the resulting strips may also contact mostly the front surface of the user's top row of teeth, but also partially or minimally contact the bottom edge and the rear surface of the user's top row of teeth.

Similarly, the second whitening strip 6 has a first edge 11 and a second edge 12, as shown in FIG. 1. The second whitening strip 6 further has at least one perforation 7, at which the strip 6 may be torn, resulting in two equally or substantially equally sized whitening strips. The first of the resulting equally sized strips spans from the first edge 11 of the second whitening strip 6 to the perforation 7 and has a width shown in FIG. 2 represented by the reference number 19. The second of the resulting equally sized strips spans from the second edge 12 of the second whitening strip 6 to the perforation 7 and has a width shown in FIG. 2 represented by the reference number 18. By tearing the second whitening strip 6 into two equally sized or substantially equally sized strips, the user is provided the benefit of having two strips that may be used separately for two separate teeth whitening procedures, rather than the single use afforded when using the entire second whitening strip 6 for a single teeth whitening procedure. When the user employs use of only one of the equally sized strips resulting from tearing the second whitening strip 6 into two separate strips, the whitening strip 6 may advantageously be positioned to preferably only contact the front surface of the user's bottom row of teeth. Depending upon the size of the user's teeth, the resulting strips may also contact mostly the front surface of the user's bottom row of teeth, but also partially or minimally contact the top edge and the rear surface of the user's bottom row of teeth. Of course, alternatively, the second whitening strip 6 may be untorn and used in the conventional, single use manner such that the second whitening strip 6 contacts the front surface and the rear surface of the user's bottom row of teeth when applied by the user for whitening.

FIG. 1 also shows a second perforation 8 of the second whitening strip 6, at which the strip 6 may alternatively be torn, resulting in two whitening strips of varying size. The larger of the two resulting strips spans from the second edge 12 of the second whitening strip 6 to the perforation 8 and has a width shown in FIG. 2 represented by the reference number 20. The smaller of the two resulting strips spans from the first edge 11 of the second whitening strip 6 to the perforation 8 and has a width shown in FIG. 2 represented by the reference number 17. The benefit of this perforation 8 is to provide two separate whitening strips that are each sized preferably to only contact the front surface of the user's bottom row of teeth, with the resulting smaller sized strip being suitable for a user with relatively smaller sized teeth and the resulting larger sized strip being suitable for a user with relatively medium-to-larger sized teeth. Depending upon the size of the user's teeth, the resulting strips may also contact mostly the front surface of the user's bottom row of teeth, but also partially or minimally contact the top edge and the rear surface of the user's bottom row of teeth.

The teeth whitening strip 3 shown in FIG. 1, alternatively, may be used without being torn at either perforation 4, 5 and, thereby, used as whitening strips are conventionally used where the whitening strip 3 contacts the front surface of the user's top row of teeth, is folded underneath the user's top row of teeth, and contacts the rear surface of the user's top row of teeth. Likewise, for whitening the user's bottom row of teeth, the untorn whitening strip 6 may be applied to contact the front surface of the user's bottom row of teeth, to fold over the top of the user's bottom row of teeth, and to contact the rear surface of the user's bottom row of teeth.

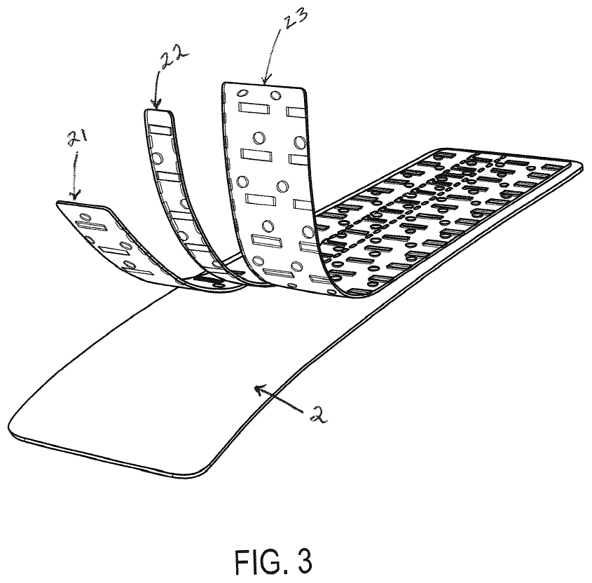

In the embodiment shown in FIG. 1, the teeth whitening system 1 includes two whitening strips 3, 6. Each whitening strip 3, 6 is removably affixed to a plastic backing 2, from which each whitening strip 3, 6 may be removed by the user prior to applying the whitening strip 3, 6 to the user's teeth. FIG. 3 shows how whitening strips 21, 23 can be removably fixed to the plastic backing 2.

FIG. 2 shows preferred dimensions of the respective teeth whitening strips 3, 6 of a preferred embodiment of the present invention. In the embodiment of FIG. 2, the whitening strip 3 for the upper row of teeth is about 75 mm in length and about 15 mm in width. The first perforation 4 is located on the whitening strip 3 about 7.5 mm measured from the bottom edge 10 of the whitening strip 3. The second perforation 5 is located on the whitening strip 3 about 5 mm measured from the top edge 9 of the whitening strip 3. The whitening strip 6 for the bottom row of teeth is about 57 mm in length and about 15 mm in width. The first perforation 7 is located on the whitening strip 6 about 7.5 mm measured from the bottom edge 12 of the second whitening strip 6. The second perforation 8 is located on the second whitening strip 6 about 5 mm measured from the top edge 11 of the second whitening strip 6. Although these dimensions are provided for the preferred embodiment shown in FIG. 2, by way of example only, the present invention is not limited to these particular dimensions and those skilled in the art would understand that embodiments of the present invention can have varying dimensions to suit different sizes of teeth. The perforations provided on the whitening strips of the present invention can be positioned on the at any position on the respective whitening strips to accommodate different sizes of teeth. Nothing in this disclosure should be interpreted to limit the dimensions of the whitening strips of the present invention to exclude any sizing that is appropriate for fitting the many different sizes of users'teeth.

Although the preferred embodiments described herein comprise two whitening strips, the present invention is not limited in terms of the number of whitening strips included and, in fact, can include one or more whitening strips. Any number of whitening strips, with any dimensions suitable for any size teeth, may be included and provided by the present invention.

Having described the preferred embodiment of the present invention, any number of changes, variations and improvements which may be apparent to those skilled in the art are within the scope of the invention claimed and described herein. As various changes could be made in the above constructions without departing from the scope of the invention, it is intended that all matter contained in the above description or shown in the accompanying drawings shall be interpreted as illustrative and not limiting in any manner.

What is claimed is:

1. A teeth whitening system comprising:
a plastic backing;
at least one strip of flexible material removably adhered to said plastic backing, wherein said strip has at least one perforation at which said strip may be torn into two separate strips; and
a thin layer of an oral care composition coating said strip.

2. A teeth whitening system according to claim 1, wherein two strips of flexible material are provided.

3. A teeth whitening system according to claim 1, wherein said strip has two separate perforations at which said strip may be torn.

4. A teeth whitening system according to claim 1, wherein said oral care composition is a teeth whitening gel.
